(19) United States
(12) Patent Application Publication
(10) Pub. No.: US 2025/0118001 A1
(43) Pub. Date: Apr. 10, 2025

(54) METHOD AND APPARATUS FOR OBTAINING A COVER IMAGE, METHOD AND APPARATUS FOR TRAINING AN IMAGE SCORING MODEL

(71) Applicant: BEIJING BAIDU NETCOM SCIENCE TECHNOLOGY CO., LTD., Beijing (CN)

(72) Inventors: Zhaoxu Wang, Beijing (CN); Qiang Xie, Beijing (CN); Yuhang Zheng, Beijing (CN); Tao Li, Beijing (CN); Shouke Qin, Beijing (CN); Zonggang Wu, Beijing (CN); Qian Wu, Beijing (CN); Weijian Jian, Beijing (CN); Ruohan Chang, Beijing (CN); Di Meng, Beijing (CN); Yuanhua Shao, Beijing (CN); Xiaoyun Han, Beijing (CN); Yang Yang, Beijing (CN)

(73) Assignee: BEIJING BAIDU NETCOM SCIENCE TECHNOLOGY CO., LTD., Beijing (CN)

(21) Appl. No.: 18/988,095

(22) Filed: Dec. 19, 2024

(30) Foreign Application Priority Data
Sep. 13, 2024 (CN) 202411288768.3

(51) Int. Cl. G06T 11/60; G06T 7/00; G06T 7/11; G06V 10/764; G06V 10/77; G06V 10/776; G06V 10/82; G06V 30/18; G06V 30/262

(52) U.S. Cl. CPC G06T 11/60; G06T 7/0002; G06T 7/11; G06V 10/764; G06V 10/7715; G06V 10/776; G06V 10/82; G06V 30/18; G06V 30/262; G06T 2207/20072; G06T 2207/20081; G06T 2207/20084; G06T 2207/20132; G06T 2207/30168

(57) ABSTRACT

A method for obtaining a cover image includes: obtaining a plurality of first cropped images of an original image corresponding to a candidate resource; obtaining an aesthetic score of each of the plurality of first cropped images; and determining a target cover image of the candidate resource from the plurality of first cropped images based on the aesthetic score of each first cropped image.

### CROSS REFERENCE TO RELATED APPLICATION

This application claims priority to Chinese patent application No. 2024112887683, filed on Sep. 13, 2024, the entire content of which is hereby introduced into this application as a reference.

### TECHNICAL FIELD

The present disclosure relates to a field of artificial intelligence technology, specifically to fields of computer vision, deep learning, and large model technology, and specifically to a method and an apparatus for obtaining a cover image, and a method and an apparatus for training an image scoring model.

### BACKGROUND

With development of Internet technology, recommendation of articles, web pages, videos and other resources to users based on the network has advantages of wide coverage and strong immediacy, and has been widely used. For example, resources may be recommended to the users via web pages, applications and other media.

### SUMMARY

The present disclosure provides a method and an apparatus for obtaining a cover image, a method and an apparatus for training an image scoring model.

According to a first aspect of the present disclosure, a method for obtaining a cover image is provided, including: obtaining a plurality of first cropped images of an original image corresponding to a candidate resource; obtaining an aesthetic score of each of the plurality of first cropped images; and determining a target cover image of the candidate resource from the plurality of first cropped images based on the aesthetic score of each first cropped image.

According to a second aspect of the present disclosure, a method for training an image scoring model is provided, including: obtaining a reference cropped image and a sample cropped image of a sample image; obtaining a coincidence parameter between each of the plurality of sample cropped images and the reference cropped image; obtaining a slicing detection result of the sample cropped image by performing object slicing detection on the sample cropped image; obtaining a sample aesthetic score of the sample cropped image; obtaining a sample target score of the sample cropped image based on at least one of the coincidence parameter, the slicing detection result, or the sample aesthetic score; and training an image scoring model based on the sample cropped image and the sample target score.

According to a third aspect of the present disclosure, an apparatus for obtaining a cover image is provided, including: at least one processor; and a memory communicatively coupled to the at least one processor, in which the memory stores instructions executable by the at least one processor, the instructions causes the at least one processor to: obtain a plurality of first cropped images of an original image corresponding to a candidate resource; obtain an aesthetic score of each of the plurality of first cropped images; and determine a target cover image of the candidate resource from the plurality of first cropped images based on the aesthetic score of each first cropped image.

### BRIEF DESCRIPTION OF THE DRAWINGS

The accompanying drawings are used for a better understanding of the disclosure and do not constitute a limitation of the disclosure.

FIG. 1 is a flowchart of a method for obtaining a cover image according to an embodiment of the present disclosure.

FIG. 2 is a flowchart of a method for obtaining a cover image according to another embodiment of the present disclosure.

FIG. 3 is a flowchart of a method for obtaining a cover image according to another embodiment of the present disclosure.

FIG. 4 is a flowchart of a method for obtaining a cover image according to another embodiment of the present disclosure.

FIG. 5 is a flowchart of a method for obtaining a cover image according to another embodiment of the present disclosure.

FIG. 6 is a flowchart of a method for obtaining a cover image according to another embodiment of the present disclosure.

FIG. 7 is a flowchart of a method for obtaining a cover image according to another embodiment of the present disclosure.

FIG. 8 is a flowchart of a method for training an image scoring model according to an embodiment of the present disclosure.

FIG. 9 is a block diagram of an apparatus for obtaining a cover image according to an embodiment of the present disclosure.

FIG. 10 is a block diagram of an apparatus for training an image scoring model according to an embodiment of the present disclosure.

FIG. 11 is a block diagram of an electronic device according to an embodiment of the present disclosure.

### DETAILED DESCRIPTION

Exemplary embodiments of the present disclosure are described hereinafter in conjunction with the accompanying drawings, which include various details of the embodiments of the present disclosure in order to aid in understanding, and should be considered exemplary only. Accordingly, one of ordinary skill in the art should recognize that various changes and modifications may be made to the embodiments described herein without departing from the scope and spirit of the disclosure. Similarly, descriptions of well-known features and structures are omitted from the following description for the sake of clarity and brevity.

Artificial Intelligence (AI) is a technical science that studies and develops theories, methods, techniques and application systems for simulating, extending and expanding human intelligence. At present, the AI technology has advantages of high degree of automation, high accuracy and low cost, so that it has been widely used.

Computer Vision is to perform identification, tracking, measurement and other machine vision on an object by using cameras and computers instead of human eyes, and further to perform graphic processing, causing a computer to process the object into an image that is more suitable for observing with human eyes or for transmitting to an instrument for a detection. The computer vision is a comprehensive discipline that includes computer science and engineering, signal processing, physics, applied mathematics and statistics, neurophysiology, and cognitive science.

Deep Learning (DL) is a new research direction in the field of machine learning (ML), and is a science that learns internal rules and representation levels of sample data, causing a machine to have an ability to analyze and learn like humans and to recognize data such as texts, images, and sounds, which is widely used in speech and image recognition.

Large model is a machine learning model with a huge parameter scale and complexity, which requires a lot of computing resources and storage space to train and store, and often requires distributed computing and special hardware acceleration technologies. The large model has stronger generalization and expression ability. The large model includes a large language model (LLM). The LLM is a DL model trained using a large amount of text data, which may generate a natural language text or understand the meaning of a language text. The LLM may process a variety of natural language tasks, such as text classification, question and answer, conversation, etc., which is an important way to artificial intelligence.

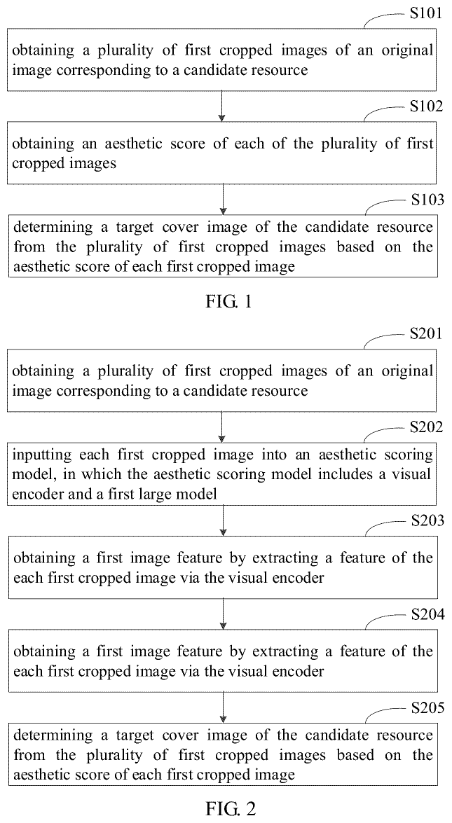

FIG. 1 is a flowchart of a method for obtaining a cover image according to an embodiment of the present disclosure. As shown in FIG. 1, the method includes following blocks.

At block S101, a plurality of first cropped images of an original image corresponding to a candidate resource is obtained.

It should be noted that an executive subject of the method for obtaining a cover image in embodiments of the present disclosure may be a hardware device with a data information processing capability and/or a software necessary to drive the work of the hardware device. For example, the executive subject may include a workstation, a server, a computer, a user terminal, and other intelligent devices. The user terminal includes but is not limited to a mobile phone, a computer, an intelligent voice interaction device, a smart home appliance, an in-vehicle/vehicle-mounted terminal, etc.

It should be noted that the candidate resource is not limited, which may include, for example, a video, an article, a web page, a product, etc. The original image may refer to an uncropped image corresponding to the candidate resource. For example, the candidate resource is a video, then the original image may include a video frame. For another example, the candidate resource is an article, then the original image may include an image carried by the article. For another example, the candidate resource is a web page, the original image may include an image carried by the web page.

It should be understood that one candidate resource may correspond to at least one original image, and one original image may correspond to a plurality of first cropped images.

It should be noted that the first cropped image may be obtained by any method for cropping an image in the related art, which is not limited here. For example, the original image may be cropped according to multiple sizes of crop boxes to obtain the plurality of first cropped images.

At block S102, an aesthetic score of each of the plurality of first cropped images is obtained.

It should be understood that aesthetic scores of different first cropped images may differ. To obtain the aesthetic score of each first cropped image, any method for obtaining an aesthetic scoring of an image in the related art may be adopted, which is not limited here.

In an implementation, obtaining the aesthetic score of each of the plurality of the first cropped images includes: inputting each first cropped image into an aesthetic scoring model, and the aesthetic score of each first cropped image is output via the aesthetic scoring model. It should be noted that the aesthetic scoring model may be implemented using any one of the aesthetic scoring models in the related art, which is not limited here.

At block S103, a target cover image of the candidate resource is determined from the plurality of first cropped images based on the aesthetic score of each first cropped image.

It should be noted that the plurality of first cropped images include a target cover image, and target cover images of different candidate resources may be different.

In an implementation, determining the target cover image of the candidate resource from the plurality of first cropped images based on the aesthetic score of each first cropped image includes: taking a first cropped image corresponding to a largest aesthetic score as the target cover image.

In an implementation, determining the target cover image of the candidate resource from the plurality of first cropped images based on the aesthetic score of each first cropped image includes: determining the target cover image from the plurality of first cropped images based on the aesthetic score of each first cropped image and other indicators except for the aesthetic score of each first cropped image.

It should be noted that other indicators except for the aesthetic score of each first cropped image are not limited, which may include a sharpness, a contrast, a brightness, and whether a target object (such as a face) is included, etc.

In some examples, determining the target cover image from the plurality of first cropped images based on the aesthetic score of each first cropped image and other indicators except for the aesthetic score of each first cropped image includes: obtaining a third score of each first cropped image based on the aesthetic score of each first cropped image and other indicators except for the aesthetic score of each first cropped image, and taking a first cropped image corresponding to a largest third score as the target cover image.

For example, the third score is positively correlated with the aesthetic score, that is, the greater the aesthetic score of a certain first cropped image is, the greater the third score of the first cropped image is.

In the he method for obtaining a cover image in embodiments of the present disclosure, the plurality of first cropped images of the original image corresponding to the candidate resource are obtained, the aesthetic score of each of the plurality of first cropped images is obtained and the target cover image of the candidate resource is determined from the plurality of first cropped images based on the aesthetic score of each first cropped image. Therefore, the target cover image may be determined from the plurality of cropped images with considering the aesthetic score of each first cropped image, which helps to obtain the cover image more aesthetic, improve a quality of the cover image, improve a matching degree between the cover image and users aesthetic, and improve user experience in resource recommendation scenarios.

In the above embodiment, obtaining the aesthetic score of each of the plurality of first cropped images in S102 may be further understood in combination with FIG. 2. FIG. 2 is a flowchart of a method for obtaining a cover image according to another embodiment of the present disclosure. As shown in FIG. 2, the method includes following blocks.

At block S201, a plurality of first cropped images of an original image corresponding to a candidate resource is obtained.

Relevant content of block S201 may refer to the above embodiment, and will not be repeated herein.

At block S202, each first cropped image is inputted into an aesthetic scoring model, in which the aesthetic scoring model includes a visual encoder and a first large model.

It should be noted that the visual encoder may use any one of visual encoders in the related art, which is not limited here. For example, the visual encoder may include a Vision Transformer (ViT), a Convolutional Neural Network (CNN), a Recurrent Neural Network (RNN), etc. The ViT may include a NaVit, which may retain an aspect ratio of an input image, is suitable for feature extraction scenarios of images with various resolutions, and has better feature extraction performance.

It should be noted that the first large model may be realized using any one of the large models in the related art, which is not limited herein. For example, the first large model may be a transformer model, a large language model, etc. It should be noted that the transformer model is a neural network model based on self-attention mechanism. For example, the first large model may be a multi-modal large model, such as a Contrastive Language-Image Pre-training (CLIP) model, which is a multi-modal pre-training model.

At block S203, a first image feature is obtained by extracting a feature of the each first cropped image via the visual encoder.

At block S204, the aesthetic score of the each first cropped image is obtained based on the first image feature via the first large model.

In an implementation, the aesthetic scoring model may include an image quality model, an image classification model and an image description model. The method may include: obtaining an image quality feature by extracting the feature of the each first cropped image via the image quality model, obtaining a category by classifying the each first cropped image via the image classification model, and obtaining a descriptive text of the each first cropped image via the image description model.

Obtaining the aesthetic score of the each first cropped image based on the first image feature via the first large model includes: obtaining the aesthetic score of the each first cropped image based on the first image feature, the image quality feature, the category and the descriptive text via the first large model.

At block S205, a target cover image of the candidate resource is determined from the plurality of first cropped images based on the aesthetic score of each first cropped image.

Relevant content of block S205 may refer to the above embodiment, and will not be repeated here.

In the method for obtaining a cover image in embodiments of the present disclosure, each first cropped image is input into the aesthetic scoring model, in which the aesthetic scoring model includes the visual encoder and the first large model, the first image feature is obtained by extracting the feature of the each first cropped image via the visual encoder, and the aesthetic score of the each first cropped image is obtained based on the first image feature via the first large model. Therefore, the aesthetic score may be obtained based on the DL technology, which improves an accuracy of the aesthetic score.

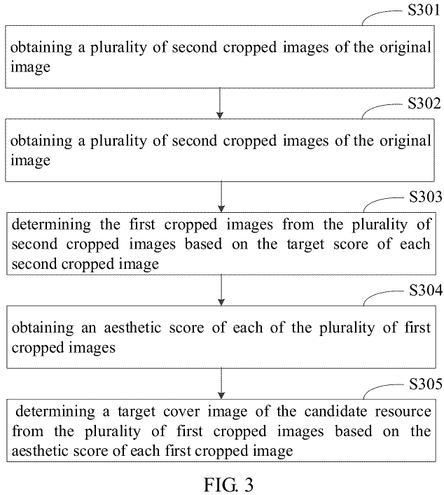

In the above embodiment, obtaining the plurality of first cropped images of the original image corresponding to the candidate resource in step S101 may be further understood in combination with FIG. 3. FIG. 3 is a flowchart of a method for obtaining a cover image according to another embodiment of the present disclosure. As shown in FIG. 3, the method includes following blocks.

At block S301, a plurality of second cropped images of the original image is obtained.

In an implementation, obtaining the plurality of second cropped images of the original image includes: obtaining a plurality of initial cropped images of the original image; obtaining a main subject area of the original image by detecting a main subject of the original image; and taking initial cropped images including the main subject area as the second cropped images. Therefore, the initial cropped images including the main subject area may be taken as the second cropped images to ensure that the cover image includes the main subject area.

It should be noted that the initial cropped image may refer to an image that is obtained by directly cropping the original image, and the plurality of initial cropped images include the second cropped images. The main subject area may refer to an area in the original image where a key object in the original image locates, such as a face area, a text area, and so on.

At block S302, a target score of each of the plurality of second cropped images is obtained.

In an implementation, obtaining the target score of each of the plurality of second cropped images includes: inputting each second cropped image into an image scoring model, and the target score of each of the plurality of second cropped images is output via the image scoring model. It should be noted that the image scoring model is not limited here. For example, the image scoring model may include a feature extraction network, a graph neural network, a scoring network, etc. The graph neural network may include a Graph Convolutional Network (GCN), a Graph Recurrent Network (GRN), and a Graph Attention Network (GAT). The training content of the image scoring model is described in the following embodiment, which will not be repeated here.

In an implementation, obtaining the target score of each of the plurality of second cropped images includes: obtaining a second image feature by extracting a feature of each second cropped image; and obtaining the target score of each second cropped image based on the second image feature. Therefore, the target score may be obtained by scoring each second cropped image based on the image feature of each second cropped image.

In an implementation, obtaining the target score of each of the plurality of second cropped images based on the second image feature includes: constructing a first graph with L first nodes based on a number L of the second cropped images, where L is a positive integer; establishing a correspondence between a k^{th} second cropped image and a k^{th} first node, where k is a positive integer less than or equal to L; determining an initial value of a feature of the k^{th} first node based on a second image feature of the k^{th} second cropped image; inputting the first graph into a first graph neural network, and updating the feature of the k^{th} first node via the first graph neural network; and obtaining a target score of the k^{th} second cropped image based on a last updated feature of the k^{th} first node. Therefore, the first graph may be constructed based on the plurality of second cropped images, and the feature of the node in the first graph may be updated via the first graph neural network, and the target score of the second cropped image corresponding to the node may be obtained based on the last updated feature of the node. Therefore, the target score may be obtained based on the DL technology, which improves an accuracy of the target score, makes generalization of the graph neural network better, and is suitable for scoring scenarios of multi-sized cropped images.

It should be noted that the second cropped image has a one-to-one correspondence with the first node. Updating the feature of the k^{th} first node via the first graph neural network may be achieved using any one of methods for updating the feature of the node of the graph neural network in the related art, which is not limited here. The methods for updating the feature of the node may include a mutual attention mechanism.

Determining the initial value of the feature of the k^{th} first node based on the second image feature of the k^{th} second cropped image includes: taking the second image feature of the k^{th} second cropped image as the initial value of the feature of the k^{th} first node.

As block S303, the first cropped images are determined from the plurality of second cropped images based on the target score of each second cropped image.

It should be noted that the plurality of second cropped images include the first cropped images.

In an implementation, determining the first cropped images from the plurality of second cropped images based on the target score of the each second cropped image includes: taking second cropped images with a target score greater than a predefined threshold as the first cropped images, and/or, ranking the plurality of second cropped images in descending order based on the target score of the each second cropped image, and taking top Q second cropped images as the first cropped images, where Q is a positive integer.

At block S304, an aesthetic score of each of the plurality of first cropped images is obtained.

At block S305, a target cover image of the candidate resource is determined from the plurality of first cropped images based on the aesthetic score of each first cropped image.

Relevant content of blocks S304 to S305 may refer to the above embodiment, and will not be repeated here.

In the method for obtaining a cover image in embodiments of the present disclosure includes, the plurality of second cropped images of the original image is obtained, the target score of each of the plurality of second cropped images is obtained, and the first cropped images are determined from the plurality of second cropped images based on the target score of each second cropped image. Therefore, the first cropped images may be determined from the plurality of second cropped images with considering the target score of each second cropped image, which helps to obtain the first cover image with a higher score, improve a quality of the cover image, and improve user experience in resource recommendation scenarios.

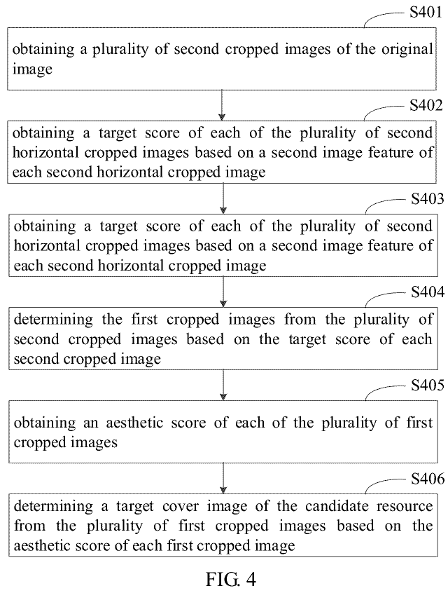

In the above embodiment, obtaining the plurality of first cropped images of the original image corresponding to the candidate resource in step S101 may be further understood in combination with FIG. 4. FIG. 4 is a flowchart of a method for obtaining a cover image according to another embodiment of the present disclosure. As shown in FIG. 4, the method includes following blocks.

At block S401, a plurality of second cropped images of the original image is obtained.

Relevant content of S401 may refer to the above embodiment, and will not be repeated here.

At block S402, a target score of each of a plurality of second horizontal cropped images is obtained based on a second image feature of each second horizontal cropped image.

In an embodiment, the plurality of second horizontal cropped images include a plurality of second horizontal cropped images and a plurality of second vertical cropped images. The second horizontal cropped image may refer to a second cropped image obtained in a horizontal cropped manner and the second vertical cropped image may refer to a second cropped image obtained in a vertical cropped manner. Terms such as horizontal and lateral may be replaced with each other, and terms such as vertical and perpendicular may be replaced with each other.

In an implementation, obtaining the target score of each of the plurality of second horizontal cropped images based on the second image feature of each second horizontal cropped image includes: inputting the second image feature of each of the plurality of second horizontal cropped images into a first scoring model, and the target score of each second horizontal cropped image is output via the first scoring model. It should be noted that the first scoring model is not limited, which may include a feature extraction network, a second graph neural network, a scoring network, etc. The training content of the first scoring model is described in the following embodiment, which will not be repeated here.

In an implementation, obtaining the target score of each of the plurality of second horizontal cropped images based on the second image feature of each second horizontal cropped image includes: constructing a second graph with N second nodes based on a number N of the second horizontal cropped images, where N is a positive integer; establishing a correspondence between an i^{th} second horizontal cropped image and an i^{th} second node, where i is a positive integer less than or equal to N; determining an initial value of a feature of the i^{th} second node based on a second image feature of the i^{th} second horizontal cropped image; inputting the second graph into a second graph neural network, and updating the feature of the i^{th} second node via the second graph neural network; and obtaining a target score of the i^{th} second horizontal cropped image based on a last updated feature of the i^{th} second node. Therefore, the second graph may be constructed based on the plurality of second horizontal cropped images, and the feature of the node in the second graph may be updated via the second graph neural network, and the target score of the second horizontal cropped image corresponding to the node may be obtained based on the last updated feature of the node. Therefore, the target score of the second horizontal cropped image may be obtained based on the DL technology, which improves an accuracy of the target score of the second horizontal cropped image, makes generalization of the graph neural network better, and is suitable for scoring scenarios of multi-sized second horizontal cropped images.

It should be noted that the second horizontal cropped image has a one-to-one correspondence with the second node. Updating the feature of the i^{th} second node via the second graph neural network may be achieved using any one of methods for updating the feature of the node of the graph neural network in the related art, which is not limited here. The methods for updating the feature of the node may include a mutual attention mechanism.

Determining the initial value of the feature of the i^{th} second node based on the second image feature of the i^{th} second horizontal cropped image includes: taking the second image feature of the i^{th} second horizontal cropped image as the initial value of the feature of the i^{th} second node.

At block S403, a target score of each of the plurality of second vertical cropped images is obtained based on a second image feature of each second vertical cropped image.

In an implementation, obtaining the target score of each of the plurality of second vertical cropped images based on the second image feature of each second vertical cropped image includes: inputting the second image feature of each of the plurality of second vertical cropped images into the second scoring model, and the target score of each second vertical cropped image is output via the second scoring model. It should be noted that the second scoring model is not limited, which may include a feature extraction network, a third graph neural network, a scoring network, etc. The training content of the second scoring model may be described in the following embodiment, which will not be repeated here.

In an implementation, obtaining the target score of each of the plurality of second vertical cropped images based on the second image feature of each second vertical cropped image includes: constructing a third graph with M third nodes based on a number M of the second vertical cropped images, where M is a positive integer; establishing a correspondence between an s^{th} second vertical cropped image and an s^{th} third node, where s is a positive integer less than or equal to M; determining an initial value of a feature of the s^{th} third node based on a second image feature of the s^{th} second vertical cropped image; inputting the third graph into a third graph neural network, and updating the feature of the s^{th} third node via the third graph neural network; and obtaining a target score of the s^{th} second vertical cropped image based on a last updated feature of the s^{th} third node. Therefore, the third graph may be constructed based on the plurality of second vertical cropped images, and the feature of the node in the third graph may be updated via the third graph neural network, and the target score of the second vertical cropped image corresponding to the node may be obtained based on the last updated feature of the node. Therefore, the target score of the second vertical cropped image may be obtained based on the DL technology, which improves an accuracy of the target score of the second vertical cropped image, makes generalization of the graph neural network better, and is suitable for scoring scenarios of multi-sized second vertical cropped images.

It should be noted that the second vertical cropped image has a one-to-one correspondence with the third node. Updating the feature of the s^{th} third node via the third graph neural network may be achieved using any one of methods for updating the feature of the node of the graph neural network in the related art, which is not limited here. The methods for updating the feature of the node may include a mutual attention mechanism.

Determining the initial value of the feature of the s^{th} third node based on the second image feature of the s^{th} second vertical cropped image includes: taking the second image feature of the s^{th} second vertical cropped image as the initial value of the feature of the s^{th} third node.

At block S404, the first cropped images are determined from the plurality of second cropped images based on the target score of each second cropped image.

At block S405, an aesthetic score of each of the plurality of first cropped images is obtained.

At block S406, a target cover image of the candidate resource is determined from the plurality of first cropped images based on the aesthetic score of each first cropped image.

Relevant content of blocks S404 to S406 may refer to the above embodiment, and will not be repeated here.

In the method for obtaining a cover image in embodiments of the present disclosure includes, the target score of each of the plurality of second horizontal cropped images is obtained based on the second image feature of each second horizontal cropped image, the target score of each of the plurality of second vertical cropped images is obtained based on the second image feature of each second vertical cropped image. Therefore, the target score of each of the plurality of second horizontal cropped images may be obtained with considering the second image feature of each second horizontal cropped image, and the target score of each of the plurality of second vertical cropped images may be obtained with considering the second image feature of each second vertical cropped image, and the target score of each type of second cropped image of the second horizontal cropped images and the second vertical cropped images may be obtained separately, that is, the image feature of each second horizontal cropped images is independent of obtaining the target score of each second vertical cropped images, and the image feature of each second vertical cropped image is independent of obtaining the target score of each second horizontal cropped image, which is helpful to improve an accuracy of the target score.

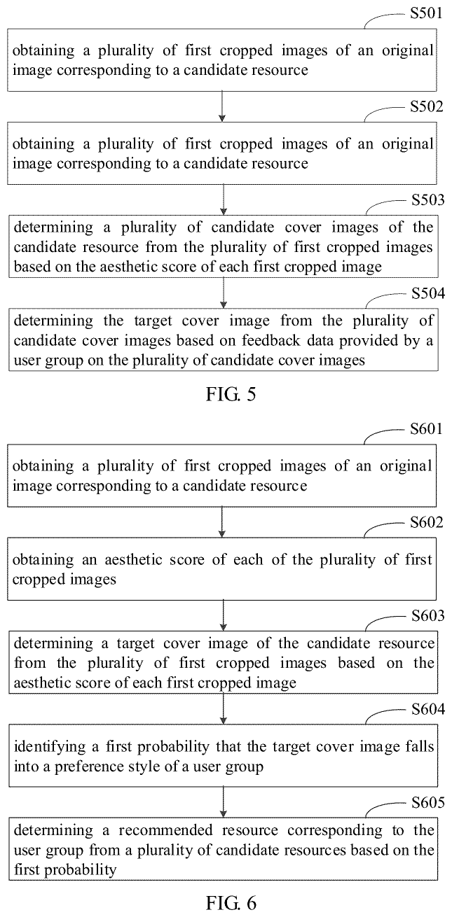

In the above embodiment, obtaining the target cover image of the candidate resource from the plurality of first cropped images based on the aesthetic score of each first cropped image in step S103 may be further understood in combination with FIG. 5. FIG. 5 is a flowchart of a method for obtaining a cover image according to another embodiment of the present disclosure. As shown in FIG. 5, the method includes following blocks.

At block S501, a plurality of first cropped images of an original image corresponding to a candidate resource is obtained.

At block S502, an aesthetic score of each of the plurality of first cropped images is obtained.

Relevant content of blocks S501 to S502 may refer to the above embodiment, and will not be repeated here.

At block S503, a plurality of candidate cover images of the candidate resource are determined from the plurality of first cropped images based on the aesthetic score of each first cropped image.

It should be noted that the plurality of first cropped images may include the plurality of candidate cover images. There are a plurality of candidate cover images.

In an implementation, determining the plurality of candidate cover images of the candidate resource from the plurality of first cropped images based on the aesthetic score of each first cropped image includes: taking a first cropped image corresponding to a largest aesthetic score as a candidate cover image.

In an implementation, determining the plurality of candidate cover images of the candidate resource from the plurality of first cropped images based on the aesthetic score of each first cropped image includes: determining the plurality of candidate cover images from the plurality of first cropped images based on the aesthetic score of each first cropped image and other indicators except for the aesthetic score of each first cropped image.

It should be noted that other indicators except for the aesthetic score of each first cropped image are not limited, which may include a sharpness, a contrast, a brightness, and whether a target object (such as a face) is included.

In some examples, determining the plurality of candidate cover images from the plurality of first cropped images based on the aesthetic score of each first cropped image and other indicators except for the aesthetic score of each first cropped image includes: obtaining a third score of each first cropped image based on the aesthetic score of each first cropped image and other indicators except for the aesthetic scores of each first cropped image, and taking a first cropped image corresponding to a largest third score as the candidate target cover image.

For example, the third score is positively correlated with the aesthetic score, that is, the greater the aesthetic score of a first cropped image is, the greater the third score of the first cropped image is.

At block S504, the target cover image is determined from the plurality of candidate cover images based on feedback data provided by a user group on the plurality of candidate cover images.

It should be noted that the feedback data corresponding to the candidate cover image may refer to the feedback data provided by the user group on the plurality of candidate cover images when a candidate resource is recommended to the user group using the candidate cover image as the cover image of the candidate resource. The feedback data may include a number of visits, a time of visits, a number of likes, a number of clicks, a Click-Through Rate (CTR), etc., when the user group views the candidate cover image or the candidate resource. The plurality of candidate cover images include the target cover image, which may be dynamically updated.

It should be understood that in the resource recommendation process, the feedback data may be updated over time, so that the target cover image may be different when recommending the same candidate resource to the same user group multiple times, thus improving flexibility of the cover image.

It should be understood that the feedback data provided by different user groups on the same candidate cover image may be different, the feedback data provided by the same user group on different candidate cover images may be different, and the target cover image may be different when recommending the same candidate resource to different user groups, so as to achieve personalized matching of the cover image.

For example, based on feedback data provided by user group A on candidate cover images 1 to 3 of the candidate resource, candidate cover image 1 is determined from the candidate cover images 1 to 3, and is taken as the target cover image when recommending the candidate resource to the user group A.

For example, based on feedback data provided by user group B on candidate cover images 1 to 3 of the candidate resource, candidate cover image 2 is determined from the candidate cover images 1 to 3, and is taken as the target cover image when recommending the candidate resource to the user group B.

In an implementation, determining the target cover image from the plurality of candidate cover images based on the feedback data provided by the user group on the plurality of candidate cover images includes: obtaining a fourth score of each of the plurality of candidate cover images based on the feedback data corresponding to the plurality of candidate cover images, and taking a candidate cover image corresponding to a largest fourth score as the target cover image.

In an implementation, determining the target cover image from the plurality of candidate cover images based on the feedback data provided by the user group on the plurality of candidate cover images includes: obtaining an average reward of each of the plurality of candidate cover images based on feedback data corresponding to each candidate cover image; obtaining an upper confidence bound score of the candidate cover image based on an exploration parameter, the average reward and a selection times of the candidate cover image; and taking a candidate cover image corresponding to a maximum upper confidence bound score as the target cover image. Therefore, the average reward of each of the plurality of candidate cover images may be obtained based on the feedback data, the upper confidence bound score of the candidate cover image may be obtained, and the candidate cover image corresponding to the maximum upper confidence bound score is taken as the target cover image. The Upper Confidence Bound (UCB) method may be used to determine the target cover image from a plurality of candidate cover images, which is helpful to increase diversity of the cover image.

It should be noted that a selection times of candidate cover images may refer to the number of impressions of candidate cover images.

In some examples, obtaining the average reward of each of the plurality of candidate cover images based on the feedback data corresponding to each candidate cover image includes: obtaining a reward of each of the plurality of candidate cover images in a r^{th} display based on the feedback data provided by the user group on the plurality of candidate cover images in the process of the r^{th} display, where r is a positive integer less than or equal to P, P is a selection times of the candidate cover image, and P is a positive integer; and obtaining an average value of rewards of the plurality of candidate cover images in P displays, and taking the average value as the average reward.

In some examples, obtaining the upper confidence bound score of the candidate cover image based on the exploration parameter, the average reward and the selection times of the candidate cover image may be realized by the following formula:

$$UC {B}_{j} = {x}_{j} + c \sqrt{\frac{lnj}{{p}_{j}}}$$

where j represents a sum value of the selection times of the plurality of candidate cover images, that is, a cumulative recommendation times of the candidate resource; UCBⱼ represents an upper confidence bound score of the candidate cover image when the cumulative recommendation times is j; xⱼ represents an average reward of the candidate cover image when the cumulative recommendation times is j; c represents the exploration parameter; and pⱼ represents the selection times of the candidate cover image when the cumulative recommendation times is j.

In some examples, the exploration parameter may be a fixed value, such as 1, 2, etc.

In some examples, the method also includes updating the exploration parameter based on a sum value of selection times of the plurality of candidate cover images. Therefore, the exploration parameter may be updated in real time with considering the sum value of the selection times of the plurality of candidate cover images, which improves flexibility of the exploration parameter.

For example, the sum value of the selection times of the plurality of candidate cover images is negatively correlated with the exploration parameter.

For example, a mapping relationship between a candidate interval and a candidate parameter may be obtained, a target interval in which the sum value of the selection times of the plurality of candidate cover images is located is identified from a plurality of candidate intervals, and a candidate parameter with the mapping relationship with the target interval may be obtained and taken as the exploration parameter.

In the method for obtaining a cover image in embodiments of the present disclosure, the plurality of candidate cover images of the candidate resource are determined from the plurality of first cropped images based on the aesthetic score of each first cropped image, the target cover image is determined from the plurality of candidate cover images based on the feedback data provided by the user group on the plurality of candidate cover images. Therefore, the plurality of candidate cover images may be determined from the plurality of first cropped images with considering the aesthetic score of each first cropped image, and the target cover image is determined from the plurality of candidate cover images with considering the feedback data provided by the user group on the plurality of candidate cover images. Compared with a fixed cover image of a resource in the related art, the cover image in this solution may be dynamically updated with the feedback data, which improves diversity of the cover image.

FIG. 6 is a flowchart of a method for obtaining a cover image according to another embodiment of the present disclosure. As shown in FIG. 6, the method includes following blocks.

At block S601, a plurality of first cropped images of an original image corresponding to a candidate resource is obtained.

At block S602, an aesthetic score of each of the plurality of first cropped images is obtained.

At block S603, a target cover image of the candidate resource is determined from the plurality of first cropped images based on the aesthetic score of each first cropped image.

Relevant content of blocks S601 to S603 may refer to the above embodiments, and will not be repeated here.

As block S604, a first probability that the target cover image falls into a preference style of a user group is identified.

It should be understood that preference styles of different user groups may be different, and the first probability that the same target cover image falls into different preference styles may be different. Identifying the first probability that the target cover image falls into the preference style of the user group may be realized by any one of the style recognition methods of images in the related art, which is not limited here.

In an implementation, identifying the first probability that the target cover image falls into the preference style of the user group includes: inputting the target cover image into a style recognition model, and the first probability is output via the style recognition model. It should be noted that the style recognition model may be realized by any one of the style recognition models in the related art, which is not limited here.

In an implementation, identifying the first probability that the target cover image falls into the preference style of the user group includes: obtaining a third image feature by extracting a feature of the target cover image, and obtaining the first probability based on the third image feature.

At block S605, a recommended resource corresponding to the user group is determined from a plurality of candidate resources based on the first probability.

It should be noted that the plurality of candidate resources include a recommended resource. Different user groups may have different recommended resources, which may realize personalized matching of the recommended resource.

In an implementation, determining the recommended resource corresponding to the user group from the plurality of candidate resources based on the first probability includes: taking candidate resources with the first probability greater than a predefined threshold as the recommended resources, and/or, ranking the plurality of candidate resources in descending order based on the first probability, and taking top Q candidate resources as the recommended resources, where Q is a positive integer.

In an implementation, determining the recommended resource corresponding to the user group from the plurality of candidate resources based on the first probability includes: determining the recommended resource from the plurality of candidate resources based on the first probability and other indicators except for the first probability of each candidate resource.

It should be noted that other indicators except for the first probability are not limited, which may include a CTR, a Conversion Rate (CVR), an interaction rate, a return visit rate, a Video Completion Rate (VCR), etc.

In some examples, determining the recommended resource from the plurality of candidate resources based on the first probability and other indicators except for the first probability of each candidate resource includes: obtaining a fifth score of the plurality of candidate resources based on the first probability and other indicators except for the first probability of each candidate resource, and determining the recommended resource from the plurality of candidate resources based on the fifth score.

In the method for obtaining a cover image in embodiments of the present disclosure, the first probability that the target cover image falls into the preference style of the user group is identified, and the recommended resource corresponding to the user group is determined from the plurality of candidate resources based on the first probability. Therefore, the recommended resource corresponding to the user group is determined from the plurality of candidate resources with considering the first probability that the target cover image falls into the preference style of the user group, and the resource that falls into the preference style of the user group may be recommended to the user group, so as to realize personalized resource recommendation and improve an accuracy of resource recommendation.

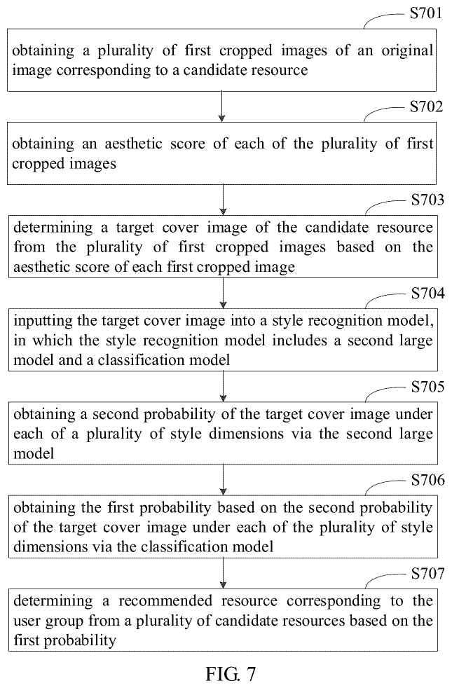

FIG. 7 is a flowchart of a method for obtaining a cover image according to another embodiment of the present disclosure. As shown in FIG. 7, the method includes following blocks.

At block S701, a plurality of first cropped images of an original image corresponding to a candidate resource is obtained.

At block S702, an aesthetic score of each of the plurality of first cropped images is obtained.

At block S703, a target cover image of the candidate resource is determined from the plurality of first cropped images based on the aesthetic score of each first cropped image.

Relevant content of blocks S701 to S703 may refer to the above embodiments, and will not be repeated here.

At block S704, the target cover image is inputted into a style recognition model, in which the style recognition model includes a second large model and a classification model.

It should be noted that relevant content of the second large model may refer to the relevant content of the first large model, which will not be repeated here. For example, the second large model may include a Random Forest (RF) model, a logistic regression model, a DL model, an eXtreme gradient boosting (Xgboost) model, etc.

At block S705, a second probability of the target cover image under each of a plurality of style dimensions is obtained via the second large model.

It should be noted that the style dimension is not excessively limited, which may include happy, warm, casual, and so on. The second probability of the target cover image may be different in different style dimensions.

In an implementation, the second large model includes a text encoder and an image encoder.

Obtaining the second probability of the target cover image under each of the plurality of style dimensions via the second large model includes: obtaining positive and negative prompt word pairs of H style dimensions, and inputting a positive and negative prompt word pair of a t^{th} style dimension into the text encoder, in which each of the positive and negative prompt word pairs includes a positive prompt word and a negative prompt word, H is a positive integer, and t is a positive integer less than or equal to H; obtaining a first text feature by extracting a feature of a positive prompt word of the t^{th} style dimension via the text encoder, and obtaining a second text feature by extracting a feature of a negative prompt word of the t^{th} style dimension; obtaining a third image feature by extracting a feature of the target cover image via the image encoder; obtaining a positive probability of the target cover image under the t^{th} style dimension based on the first text feature and the third image feature; obtaining a negative probability of the target cover image under the t^{th} style dimension based on the second text feature and the third image feature; and taking the positive probability of the target cover image under the t^{th} style dimension and the negative probability of the target cover image under the t^{th} style dimension as a second probability of the target cover image under the t^{th} style dimension.

The third image feature is obtain via the image encoder by extracting the feature of the target cover image. The positive probability of the target cover image under the t^{th} style dimension is obtained based on the first text feature and the third image feature. The negative probability of the target cover image under the t^{th} style dimension is obtained based on the second text feature and the third image feature. The positive probability of the target cover image under the t^{th} style dimension and the negative probability of the target cover image under the t^{th} style dimension are taken as the second probability of the target cover image under the t^{th} style dimension.

Therefore, in the method, the first text feature and the second text feature is obtained via the text encoder by extracting the feature of the positive prompt word and the feature of the negative prompt word, and the third image feature is obtained via the image encoder by extracting the feature of the target cover image. The positive probability of the target cover image is obtained with considering the first text feature and the third image feature, and the negative probability of the target cover image is obtained with considering the second text feature and the third image feature, and the positive probability of the target cover image and the negative probability of the target cover image are taken as the second probability.

It should be noted that the positive probability of the target cover image under the t^{th} style dimension may refer to a probability that the target cover image conforms to the t^{th} style dimension, and the negative probability of the target cover image under the t^{th} style dimension may refer to a probability that the target cover image does not conform to the t^{th} style dimension. A sum of the positive probability of the target cover image under the t^{th} style dimension and the negative probability of the target cover image under the t^{th} style dimension is 1.

In some examples, obtaining the positive probability of the target cover image under the t^{th} style dimension based on the first text feature and the third image feature includes: obtaining a similarity between the first text feature and the third image feature, and taking the similarity as the positive probability of the target cover image under the t^{th} style dimension.

In some examples, obtaining the negative probability of the target cover image under the t^{th} style dimension based on the second text feature and the third image feature includes: obtaining a similarity between the second text feature and the third image feature, and taking the similarity as the negative probability of the target cover image under the t^{th} style dimension.

In some examples, the Contextual Optimization of Prompts (CoOp) model may be used to optimize the positive and negative prompt word pairs of H style dimensions.

At block S706, the first probability is obtained based on the second probability of the target cover image under each of the plurality of style dimensions via a classification model.

It should be noted that obtaining the first probability based on the second probability of the target cover image under each of the plurality of style dimensions via the classification model may be realized using processing logics of any one of classification models in the related art, which is not limited here.

At block S707, a recommended resource corresponding to the user group is determined from a plurality of candidate resources based on the first probability.

Relevant content of block S707 may refer to the above embodiment, and will not be repeated here.

In the method for obtaining a cover image in embodiments of the present disclosure, the target cover image is input into the style recognition model, in which the style recognition model includes the second large model and the classification model, the second probability of the target cover image under each of the plurality of style dimensions is obtained via the second large model, and the first probability is obtained based on the second probability of the target cover image under each of the plurality of style dimensions via the classification model. In this way, the first probability is obtained. Therefore, the first probability may be obtained based on the DL technology, which improves an accuracy of the first probability.

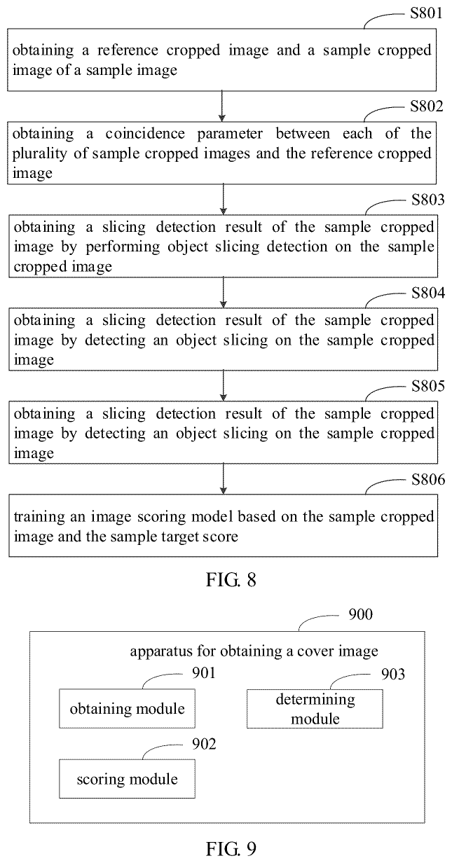

FIG. 8 is a flowchart of a method for training an image scoring model according to an embodiment of the present disclosure. As shown in FIG. 8, the method includes following blocks.

At block S801, a reference cropped image and a sample cropped image of a sample image are obtained.

It should be noted that an executive subject of the method for obtaining a cover image in embodiments of the present disclosure may be a hardware device with data information processing capability and/or a software necessary to drive the work of the hardware device. For example, the executive subject may include a workstation, a server, a computer, a user terminal, and other intelligent devices. The user terminal may include but is not limited to a mobile phone, a computer, an intelligent voice interaction device, a smart home appliance, an in-vehicle/vehicle-mounted terminal, etc.

It should be noted that the sample image is an uncropped image, and one sample image includes at least one reference cropped image and at least one sample cropped image. For example, the reference cropped image may be obtained by manual annotation, and the sample cropped image may be obtained by any one of methods for cropping an image in the related art, which is not limited here. For example, a plurality of sample cropped images may be obtained by cropping the sample image according to multiple sizes of crop boxes.

At block S802, a coincidence parameter between each of the plurality of sample cropped images and the reference cropped image is obtained.

It should be noted that the coincidence parameter is not limited, which may include a similarity, a size of a coincident area, a proportion of the coincident area, etc.

In an implementation, obtaining the coincidence parameter between each of the plurality of sample cropped images and the reference cropped image includes: obtaining an intersection over union (IoU) between a crop box of the sample cropped image and a crop box of the reference cropped image, and taking the IoU as the coincidence parameter. Therefore, the IoU between the crop box of the sample cropped image and the crop box of the reference cropped image may be taken as the coincidence parameter.

In an implementation, the plurality of sample cropped images include a plurality of sample horizontal cropped images and a plurality of sample vertical cropped images, and the reference cropped image includes a reference horizontal cropped image and a reference vertical cropped image.

Obtaining the coincidence parameter between each of the plurality of sample cropped images and the reference cropped image includes: obtaining a coincidence parameter between each of the plurality of sample horizontal cropped images and the reference horizontal cropped image, and taking the coincidence parameter as a coincidence parameter corresponding to each sample horizontal cropped image; and obtaining a coincidence parameter between each of the plurality of sample vertical cropped images and the reference vertical cropped image, and taking the coincidence parameter as a coincidence parameter corresponding to each sample vertical cropped image. Therefore, different reference cropped images may be used to obtain the coincidence parameter corresponding to each sample horizontal cropped image and the coincidence parameter corresponding to each sample vertical cropped image, that is, the reference horizontal cropped image is independent of obtaining the coincidence parameter corresponding to each sample vertical cropped image, and the reference vertical cropped image is independent of obtaining the coincidence parameter corresponding to each sample horizontal cropped image, which is helpful to improve an accuracy of the coincident parameter.

It should be noted that the sample horizontal cropped image may refer to a sample cropped image obtained in a horizontal cropped manner, the sample vertical cropped image may refer to a sample cropped image obtained in a vertical cropped manner, the reference horizontal cropped image may refer to a reference cropped image obtained in a horizontal cropped manner, and the reference vertical cropped image may refer to a reference cropped image obtained in a vertical cropped manner.

At block S803, a slicing detection result of the sample cropped image is obtained by performing object slicing detection on the sample cropped image.

It should be noted that the object slicing detection may refer to detection of whether an object in the sample cropped image is not fully displayed, that is, whether there is an object slicing. The object slicing detection is not limited, which may include a face slicing detection, a text slicing detection, and so on. The object slicing detection may be achieved by using any one of object slicing detection methods in the related art, which is not limited here.

It should be noted that the slicing detection result is not limited, which may include whether there is object slicing, a degree parameter of the object slicing, etc.

At block S804, a sample aesthetic score of the sample cropped image is obtained.

It should be noted that relevant content of block S804 may refer to the relevant content of block S102, which will not be repeated here.

In an implementation, obtaining the sample aesthetic score of the sample cropped image includes: inputting the sample cropped image into an aesthetic scoring model, in which the aesthetic scoring model includes a visual encoder and a first large model; obtaining a sample image feature by extracting a feature of the sample cropped image via the visual encoder; and obtaining the sample aesthetic score based on the sample image feature via the first large model. Therefore, the sample aesthetic score may be obtained based on the DL technology, which improves the accuracy of the sample aesthetic score.

At block S805, a sample target score of the sample cropped image is obtained based on at least one of the coincidence parameter, the slicing detection result, or the sample aesthetic score.

In an implementation, the coincidence parameter is positively correlated with the sample target score, that is, the larger the coincidence parameter corresponding to a certain sample cropped image is, the larger the sample target score of the sample cropped image is.

In an implementation, the sample aesthetic score is positively correlated with the sample target score, that is, the larger the sample aesthetic score of a certain sample cropped image is, the larger the sample target score of the sample cropped image is.

In an implementation, obtaining the sample target score of the sample cropped image based on at least one of the coincidence parameter, the slicing detection result, or the sample aesthetic score includes: in response to the slicing detection result indicating that an object slicing is present in the sample cropped image, determining a slicing score of the sample cropped image as a first score; in response to the slicing detection result indicating that the object slicing is absent in the sample cropped image, determining the slicing score as a second score, in which the first score is less than the second score; and obtaining the sample target score based on at least one of the coincidence parameter, the slicing score, or the sample aesthetic score. Therefore, the slicing score may be determined based on whether the object slicing is present in the sample cropped image, and the slicing score when the object slicing is present is smaller than the slicing score when the object slicing is absent, so that the trained target scoring model may give a low score to the cropped image with the object slicing and give a high score to the cropped image without the object slicing, so as to ensure that the cover image without the object slicing is screened out from the cropped image, thus improving a quality of the cover image. The sample target score is obtained based on at least one of the coincidence parameter, the slicing score, or the sample aesthetic score, which improves an accuracy of the sample target score.

It should be noted that, the first score and the second score are not limited, for example, the first score is a negative number, and the second score is a positive number.

In some examples, obtaining the sample target score based on at least one of the coincidence parameter, the slicing score, or the sample aesthetic score includes: obtaining the sample aesthetic score by weighting and summing the coincidence parameter, the slicing score, and the sample aesthetic score. It should be noted that the weight of the coincidence parameter, the weight of the slicing score, and the weight of the sample aesthetic score are not limited, for example, the weight of the coincidence parameter is greater than or equal to the weight of the slicing score, and the weight of the slicing score is greater than or equal to the weight of the sample aesthetic score.

At block S806, an image scoring model is trained based on the sample cropped image and the sample target score.

It should be noted that training the image scoring model based on the sample cropped image and the sample target score may be realized by using any one of the model training methods in the related art, which is not limited here.

In an implementation, training the image scoring model based on the sample cropped image and the sample target score includes: inputting the sample cropped image into the image scoring model, and outputting a predicted target score of the sample cropped image via the image scoring model; and training the image scoring model based on the predicted target score and the sample target score. Therefore, the image scoring model may be trained with considering the predicted target score and the sample target score.

In some examples, training the image scoring model based on the predicted target score and the sample target score includes: obtaining a first rank by ranking a plurality of sample cropped images according to the predicted target score of each of the plurality of sample cropped images; obtaining a second rank by ranking the plurality of sample cropped images according to the sample target score of each of the plurality of sample cropped images; obtaining a pair-wise loss function of the image scoring model based on the first rank and the second rank; and training the image scoring model based on the pair-wise loss function. Therefore, the image scoring model may be trained based on the pair-wise loss function of the sample cropped image.

In some examples, training the image scoring model based on the pair-wise loss function includes: obtaining a regression loss function of the image scoring model based on the predicted target score and the sample target score, obtaining a total loss function of the image scoring model based on the regression loss function and the pair-wise loss function, and training the image scoring model based on the total loss function. For example, the total loss function may be obtained by summing the regression loss function and the pair-wise loss function.

It should be noted that the regression loss function is not limited, which may include a Cross Entropy (CE), a Mean-Square Error (MSE), a Kullback-Leibler (KL) Divergence, a contrastive loss function, etc.

In the method for training an image scoring model in embodiments of the present disclosure, the reference cropped image and the sample cropped image of the sample image are obtained, the coincidence parameter between each of the plurality of sample cropped images and the reference cropped image is obtained, the slicing detection result of the sample cropped image is obtained by performing object slicing detection on the sample cropped image, the sample aesthetic score of the sample cropped image is obtained, the sample target score of the sample cropped image is obtained based on at least one of the coincidence parameter, the slicing detection result, or the sample aesthetic score, and the image scoring model is trained based on the sample cropped image and the sample target score. Therefore, the sample target score of the sample cropped image may be obtained based on at least one of the coincidence parameter, the slicing detection result, or the sample aesthetic score, which improves the accuracy of the sample target score, automatically obtains the sample target score without manual annotation, saves a time and costs of the sample annotation, and improves a training efficiency of the image scoring model. Besides, in the training process, the target scoring model may learn a relationship between the sample cropped image and at least one of the coincidence parameter, the slicing detection result, or the sample aesthetic score, so that the trained target scoring model may score a cropped image based on at least one of the coincidence parameter, the slicing detection result, or the sample aesthetic score, which improves an accuracy of the score of the cropped image.

On the basis of any one of the above embodiments, the image scoring model includes a first scoring model, and training the image scoring model based on the sample cropped image and the sample target score includes: inputting the sample horizontal cropped image into the first scoring model, and outputting a predicted target score of the sample horizontal cropped image via the first scoring model; and training the first scoring model based on the predicted target score of the sample horizontal cropped image and the sample target score of the sample horizontal cropped image. Therefore, the first scoring model may be trained based on the predicted target score of the sample horizontal cropped image and the sample target score of the sample horizontal cropped image, and the first scoring model may learn the relationship between the sample horizontal cropped image and its sample target score in the training process, so that the trained first scoring model may score the horizontal cropped image.

It should be noted that relevant content of training the first scoring model based on the predicted target score of the sample horizontal cropped image and the sample target score of the sample horizontal cropped image may refer to the relevant content of S806, which will not be repeated here.

In some examples, training the first scoring model based on the predicted target score of the sample horizontal cropped image and the sample target score of the sample horizontal cropped image includes: obtaining a third rank by ranking a plurality of sample horizontal cropped images according to the predicted target score of each of the plurality of sample horizontal cropped images; obtaining a fourth rank by ranking the plurality of sample horizontal cropped images according to the sample target score of each of the plurality of sample horizontal cropped images; obtaining a first pair-wise loss function of the first scoring model based on the third rank and the fourth rank; and training the first scoring model based on the first pair-wise loss function.

In some examples, training the first scoring model based on the first pair-wise loss function includes: obtaining a first regression loss function of the first scoring model based on the predicted target score of the sample horizontal cropped image and the sample target score of the sample horizontal cropped image, obtaining a total loss function of the first scoring model based on the first regression loss function and the first pair-wise loss function, and training the first scoring model based on the total loss function. For example, the total loss function may be obtained by summing the first regression loss function and the first pair-wise loss function.

On the basis of any one of the above embodiments, the image scoring model includes a second scoring model, and training the image scoring model based on the sample cropped image and the sample target score includes: inputting the sample vertical cropped image into the second scoring model, and outputting a predicted target score of the sample vertical cropped image via the second scoring model; and training the second scoring model based on the predicted target score of the sample vertical cropped image and the sample target score of the sample vertical cropped image. Therefore, the second scoring model may be trained based on the predicted target score of the sample vertical cropped image and the sample target score of the sample vertical cropped image, and the second scoring model may learn the relationship between the sample vertical cropped image and its sample target score in the training process, so that the trained second scoring model may score the vertical cropped image.

It should be noted that relevant content of training the second scoring model based on the predicted target score of the sample vertical cropped image and the sample target score of the sample vertical cropped image may refer to the relevant content of S806, which will not be repeated here.

In some examples, training the second scoring model based on the predicted target score of the sample vertical cropped image and the sample target score of the sample vertical cropped image includes: obtaining a fifth rank by ranking a plurality of sample vertical cropped images according to the predicted target score of each of the plurality of sample vertical cropped images; obtaining a sixth rank by ranking the plurality of sample vertical cropped images according to the sample target score of each of the plurality of sample vertical cropped images; obtaining a second pair-wise loss function of the second scoring model based on the fifth rank and the sixth rank; and training the second scoring model based on the second pair-wise loss function.

In some examples, training the second scoring model based on the second pair-wise loss function includes: obtaining a second regression loss function of the second scoring model based on the predicted target score of the sample vertical cropped image and the sample target score of the sample vertical cropped image, obtaining a total loss function of the second scoring model based on the second regression loss function and the second pair-wise loss function, and training the second scoring model based on the total loss function. For example, the total loss function may be obtained by summing the second regression loss function and the second pair-wise loss function.

In the technical solution of the present disclosure, the processing including collection, storage, use, shaping, transmission, provision and disclosure of the user's personal information is in compliance with the provisions of relevant laws and regulations, and do not violate public order and moral.

According to the embodiments of the present disclosure, an apparatus for obtaining a cover image is also provided, configured to realize the above method for obtaining a cover image.

FIG. 9 is a block diagram of an apparatus for obtaining a cover image according to an embodiment of the present disclosure.

As shown in FIG. 9, the apparatus 900 for obtaining a cover image includes: an obtaining module 901, a scoring module 902 and a determining module 903.

The obtaining module 901 is configured to obtain a plurality of first cropped images of an original image corresponding to a candidate resource; the scoring module 902 is configured to obtain an aesthetic score of each of the plurality of first cropped images; and the determining module 903 is configured to determine a target cover image of the candidate resource from the plurality of first cropped images based on the aesthetic score of each first cropped image.

In an embodiment of the present disclosure, the scoring module 902 is further configured to: input each first cropped image into an aesthetic scoring model, in which the aesthetic scoring model includes a visual encoder and a first large model; obtain a first image feature by extracting a feature of the each first cropped image via the visual encoder; and obtain the aesthetic score of the each first cropped image based on the first image feature via the first large model.

In an embodiment of the present disclosure, the obtaining module 901 is further configured to: obtain a plurality of second cropped images of the original image; obtain a target score of each of the plurality of second cropped images; and determine the first cropped images from the plurality of second cropped images based on the target score of each second cropped image.

In an embodiment of the present disclosure, the obtaining module 901 is further configured to: obtain a plurality of initial cropped images of the original image; obtain a main subject area of the original image by detecting a main subject of the original image; and take initial cropped images including the main subject area as the second cropped images.

In an embodiment of the present disclosure, the obtaining module 901 is further configured to: obtain a second image feature by extracting a feature of each second cropped image; and obtain the target score of each second cropped image based on the second image feature.

In an embodiment of the present disclosure, the obtaining module 901 is further configured to: construct a first graph with L first nodes based on a number L of the second cropped images, where L is a positive integer; establish a correspondence between a k^{th} second cropped image and a k^{th} first node, where k is a positive integer less than or equal to L; determine an initial value of a feature of the k^{th} first node based on a second image feature of the k^{th} second cropped image; input the first graph into a first graph neural network, and update the feature of the k^{th} first node via the first graph neural network; and obtain a target score of the k^{th} second cropped image based on a last updated feature of the k^{th} first node.

In an embodiment of the present disclosure, the plurality of second cropped images include a plurality of second horizontal cropped images and a plurality of second vertical cropped images, in which the obtaining module 901 is further configured to: obtain a target score of each of the plurality of second horizontal cropped images based on a second image feature of each second horizontal cropped image; and obtain a target score of each of the plurality of second vertical cropped images based on a second image feature of each second vertical cropped image.

In an embodiment of the present disclosure, the obtaining module 901 is further configured to: construct a second graph with N second nodes based on a number N of the second horizontal cropped images, where N is a positive integer; establish a correspondence between an i^{th} second horizontal cropped image and an i^{th} second node, where i is a positive integer less than or equal to N; determine an initial value of a feature of the i^{th} second node based on a second image feature of the i^{th} second horizontal cropped image; input the second graph into a second graph neural network, and update the feature of the i^{th} second node via the second graph neural network; and obtain a target score of the i^{th} second horizontal cropped image based on a last updated feature of the i^{th} second node.

In an embodiment of the present disclosure, the obtaining module 901 is further configured to: construct a third graph with M third nodes based on a number M of the second vertical cropped images, where M is a positive integer; establish a correspondence between an s^{th} second vertical cropped image and an s^{th} third node, where s is a positive integer less than or equal to M; determine an initial value of a feature of the s^{th} third node based on a second image feature of the s^{th} second vertical cropped image; input the third graph into a third graph neural network, and update the feature of the s^{th} third node via the third graph neural network; and obtain a target score of the s^{th} second vertical cropped image based on a last updated feature of the s^{th} third node.

In an embodiment of the present disclosure, the determining module 903 is further configured to: determine a plurality of candidate cover images of the candidate resource from the plurality of first cropped images based on the aesthetic score of each first cropped image; and determine the target cover image from the plurality of candidate cover images based on feedback data provided by a user group on the plurality of candidate cover images.

In an embodiment of the present disclosure, the determining module 903 is further configured to: obtain an average reward of each of the plurality of candidate cover images based on feedback data corresponding to each candidate cover image; obtain an upper confidence bound score of the candidate cover image based on an exploration parameter, the average reward and a selection times of the candidate cover image; and take a candidate cover image corresponding to a maximum upper confidence bound score as the target cover image.

In an embodiment of the present disclosure, the determining module 903 is further configured to: update the exploration parameter based on a sum value of selection times of the plurality of candidate cover images.

In one embodiment of the present disclosure, the determining module 903 is further configured to: identify a first probability that the target cover image falls into a preference style of a user group; and determine a recommended resource corresponding to the user group from a plurality of candidate resources based on the first probability.

In an embodiment of the present disclosure, the determining module 903 is further configured to: input the target cover image into a style recognition model, in which the style recognition model includes a second large model and a classification model; obtain a second probability of the target cover image under each of a plurality of style dimensions via the second large model; and obtain the first probability based on the second probability of the target cover image under each of the plurality of style dimensions via the classification model.

In an embodiment of the present disclosure, the second large model includes a text encoder and an image encoder; in which the determining module is further configured to: obtain positive and negative prompt word pairs of H style dimensions, and input a positive and negative prompt word pair of a t^{th} style dimension into the text encoder, in which each of the positive and negative prompt word pairs includes a positive prompt word and a negative prompt word, H is a positive integer, and t is a positive integer less than or equal to H; obtain a first text feature by extracting a feature of a positive prompt word of the t^{th} style dimension via the text encoder, and obtain a second text feature by extracting a feature of a negative prompt word of the t^{th} style dimension; obtain a third image feature by extracting a feature of the target cover image via the image encoder; obtain a positive probability of the target cover image under the t^{th} style dimension based on the first text feature and the third image feature; obtain a negative probability of the target cover image under the t^{th} style dimension based on the second text feature and the third image feature; and take the positive probability of the target cover image under the t^{th} style dimension and the negative probability of the target cover image under the t^{th} style dimension as a second probability of the target cover image under the t^{th} style dimension.

In the apparatus for obtaining a cover image in embodiments of the present disclosure, the plurality of first cropped images of the original image corresponding to the candidate resource are obtained, the aesthetic score of each of the plurality of first cropped images is obtained, and the target cover image of the candidate resource is determined from the plurality of first cropped images based on the aesthetic score of each first cropped image. Therefore, the target cover image may be determined from the plurality of cropped images with considering the aesthetic score of each first cropped image, which helps to obtain the cover image more aesthetic, improve a quality of the cover image, improve a matching degree between the cover image and users' aesthetic, and improve user experience in resource recommendation scenarios.

According to the embodiments of the present disclosure, an apparatus for training an image scoring model is also provided, configured to realize the above method for training an image scoring model.

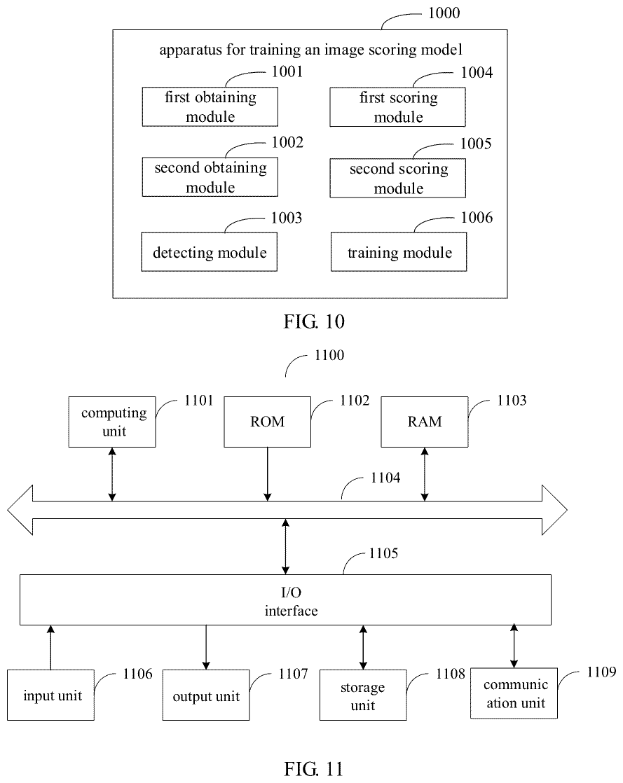

FIG. 10 is a block diagram of an apparatus for training an image scoring model according to an embodiment of the present disclosure.

As shown in FIG. 10, the apparatus 1000 for training an image scoring model includes: a first obtaining module 1001, a second obtaining module 1002, a detecting module 1003, a first scoring module 1004, a second scoring module 1005, and a training module 1006. The first obtaining module 1001 is configured to obtain a reference cropped image and a sample cropped image of a sample image; the second obtaining module 1002 is configured to obtain a coincidence parameter between each of the plurality of sample cropped images and the reference cropped image; the detecting module 1003 is configured to obtain a slicing detection result of the sample cropped image by performing object slicing detection on the sample cropped image; the first scoring module 1004 is configured to obtain a sample aesthetic score of the sample cropped image; the second scoring module 1005 is configured to obtain a sample target score of the sample cropped image based on at least one of the coincidence parameter, the slicing detection result, or the sample aesthetic score; and the training module 1006 is configured to train an image scoring model based on the sample cropped image and the sample target score.

In an embodiment of the present disclosure, the second obtaining module 1002 is further configured to: obtain an IoU between a crop box of the sample cropped image and a crop box of the reference cropped image, and take the IoU as the coincidence parameter.

In an embodiment of the present disclosure, a plurality of sample cropped images include a plurality of sample horizontal cropped images and a plurality of sample vertical cropped images, and the reference cropped image includes a reference horizontal cropped image and a reference vertical cropped image, in which the second obtaining module 1002 is further configured to: obtain a coincidence parameter between each of the plurality of sample horizontal cropped images and the reference horizontal cropped image, and take the coincidence parameter as a coincidence parameter corresponding to each sample horizontal cropped image; and obtain a coincidence parameter between each of the plurality of sample vertical cropped images and the reference vertical cropped image, and take the coincidence parameter as a coincidence parameter corresponding to each sample vertical cropped image.

In an embodiment of the present disclosure, the second scoring module 1005 is further configured to: in response to the slicing detection result indicating that an object slicing is present in the sample cropped image, determine a slicing score of the sample cropped image as a first score; in response to the slicing detection result indicating that the object slicing is absent in the sample cropped image, determine the slicing score as a second score, in which the first score is less than the second score; and obtain the sample target score based on at least one of the coincidence parameter, the slicing score, or the sample aesthetic score.

In an embodiment of the present disclosure, the first scoring module 1004 is further configured to: input the sample cropped image into an aesthetic scoring model, in which the aesthetic scoring model includes a visual encoder and a first large model; obtain a sample image feature by extracting a feature of the sample cropped image via the visual encoder; and obtain the sample aesthetic score based on the sample image feature via the first large model.

In an embodiment of the present disclosure, the training module 1006 is further configured to: input the sample cropped image into the image scoring model, and output a predicted target score of the sample cropped image via the image scoring model; and train the image scoring model based on the predicted target score and the sample target score.

In an embodiment of the present disclosure, the training module 1006 is further configured to: obtain a first rank by ranking a plurality of sample cropped images according to the predicted target score of each of the plurality of sample cropped images; obtain a second rank by ranking the plurality of sample cropped images according to the sample target score of each of the plurality of sample cropped images; obtain a pair-wise loss function of the image scoring model based on the first rank and the second rank; and train the image scoring model based on the pair-wise loss function.

In the apparatus for training an image scoring model in embodiments of the present disclosure, the reference cropped image and the sample cropped image of the sample image are obtained, the coincidence parameter between each of the plurality of sample cropped images and the reference cropped image is obtained, the slicing detection result of the sample cropped image is obtained by performing the object slicing detection on the sample cropped image, the sample aesthetic score of the sample cropped image is obtained, the sample target score of the sample cropped image is obtained based on at least one of the coincidence parameter, the slicing detection result, or the sample aesthetic score, and the image scoring model is trained based on the sample cropped image and the sample target score. Therefore, the sample target score of the sample cropped image may be obtained with considering at least one of the coincidence parameter, the slicing detection result, or the sample aesthetic score, which improves an accuracy of the sample target score, automatically obtains the sample target score without manual annotation, saves a time and costs of sample annotation, and improves a training efficiency of the image scoring model. Besides, in the training process, the target scoring model may learn the relationship between the sample cropped image and at least one of the coincidence parameter, the slicing detection result, or the sample aesthetic score, so that the trained target scoring model may score a cropped image based on at least one of the coincidence parameter, the slicing detection result, or the sample aesthetic score, which improves an accuracy of the score of the cropped image.

According to the embodiments of the present disclosure, an electronic device, a storage medium, and a computer program product are also provided.

FIG. 11 is a block diagram of an electronic device 1100 to implement the embodiments of the present disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 11, the device 1100 includes a computing unit 1101, configured to execute various appropriate actions and processes according to a computer program stored in a read-only memory (ROM) 1102 or a computer program loaded from a storage unit 1108 to a random access memory (RAM) 1103. In the RAM 1103, various programs and data required for the device 1100 may be stored. The computing unit 1101, the ROM 1102 and the RAM 1103 may be connected with each other by a bus 1104. An input/output (I/O) interface 1105 is also connected to the bus 1104.

The plurality of components in the device 1100 are connected to the I/O interface 1105, which include: an input unit 1106, for example, a keyboard, a mouse; an output unit 1107, for example, various types of displays, speakers; a storage unit 1108, for example, a magnetic disk, an optical disk; and a communication unit 1109, for example, a network card, a modem, a wireless transceiver. The communication unit 1109 allows the device 1100 to exchange information/data through a computer network such as Internet and/or various types of telecommunication networks with other devices.

The computing unit 1101 may be various types of general and/or dedicated processing components with processing and computing abilities. Some examples of a computing unit 1101 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 1101 executes various methods and processes as described above, for example, a method for determining a training data set of a large reward model. For example, in some embodiments, the method for determining a training data set of a large reward model may be further implemented as a computer software program, which is tangibly contained in a machine readable medium, such as the storage unit 1108. In some embodiments, a part or all of the computer program may be loaded and/or installed on the device 1100 via the ROM 1102 and/or the communication unit 1109. When the computer program is loaded on the RAM 1103 and executed by the computing unit 1101, one or more steps in the method for determining a training data set of a large reward model may be performed as described above. Optionally, in other embodiments, the computing unit 1101 may be configured to the method for determining a training data set of a large reward model in other appropriate ways (for example, by virtue of a firmware).

Various implementations of the systems and techniques described above may be implemented by one and/or a combination of a digital electronic circuit system, an integrated circuit system, a Field Programmable Gate Array (FPGA), an Application Specific Integrated Circuit (ASIC), an Application Specific Standard Product (ASSP), a System on Chip (SOC), a Load Programmable Logic Device (CPLD), a computer hardware, a firmware, and a software. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided for the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMs, ROMs, Electrically Programmable Read-Only-Memory (EPROM), fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user may provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein may be implemented in a computing system that includes background components (e.g., a data server), or a computing system that includes middleware components (e.g., an application server), or a computing system that includes front-end components (e.g., a user computer with a graphical user interface or a web browser, through which the user may interact with the implementation of the systems and technologies described herein), or include such background components, intermediate computing components, or any combination of front-end components. The components of the system may be interconnected by any form or medium of digital data communication (e.g., a communication network). Examples of communication networks include: a Local Area Network (LAN), a Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain.

According to the embodiments of the present disclosure, a computer program product including a computer program is also provided. When the computer program is executed by a processor, the method for obtaining a cover image in the embodiments of the present disclosure is implemented, and the steps of method for training an image scoring model in the embodiments of the present disclosure are implemented.

It should be understood that the various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made according to design requirements and other factors. Any modification, equivalent replacement and improvement made within the spirit and principle of the disclosure shall be included in the protection scope of the disclosure.

1. A method for obtaining a cover image, comprising:
obtaining a plurality of first cropped images of an original image corresponding to a candidate resource;
obtaining an aesthetic score of each of the plurality of first cropped images; and
determining a target cover image of the candidate resource from the plurality of first cropped images based on the aesthetic score of each first cropped image.

2. The method according to claim 1, wherein obtaining the aesthetic score of each of the plurality of first cropped images comprises:
inputting each first cropped image into an aesthetic scoring model, wherein the aesthetic scoring model comprises a visual encoder and a first large model;
obtaining a first image feature by extracting a feature of the each first cropped image via the visual encoder; and
obtaining the aesthetic score of the each first cropped image based on the first image feature via the first large model.

3. The method according to claim 1, wherein obtaining the plurality of first cropped images of the original image corresponding to the candidate resource comprises:
obtaining a plurality of second cropped images of the original image;
obtaining a target score of each of the plurality of second cropped images; and
determining the first cropped images from the plurality of second cropped images based on the target score of each second cropped image.

4. The method according to claim 3, wherein obtaining the plurality of second cropped images of the original image comprises:
obtaining a plurality of initial cropped images of the original image;
obtaining a main subject area of the original image by detecting a main subject of the original image; and
taking initial cropped images comprising the main subject area as the second cropped images.

5. The method according to claim 3, wherein obtaining the target score of each of the plurality of second cropped images comprises:
obtaining a second image feature by extracting a feature of each second cropped image; and
obtaining the target score of each second cropped image based on the second image feature.

6. The method according to claim 5, wherein obtaining the target score of each second cropped image based on the second image feature comprises:
constructing a first graph with L first nodes based on a number L of the second cropped images, where L is a positive integer;
establishing a correspondence between a k^{th} second cropped image and a k^{th} first node, where k is a positive integer less than or equal to L;
determining an initial value of a feature of the k^{th} first node based on a second image feature of the k^{th} second cropped image;
inputting the first graph into a first graph neural network, and updating the feature of the k^{th} first node via the first graph neural network; and
obtaining a target score of the k^{th} second cropped image based on a last updated feature of the k^{th} first node.

7. The method according to claim 5, wherein the plurality of second cropped images comprise a plurality of second horizontal cropped images and a plurality of second vertical cropped images,
wherein obtaining the target score of each second cropped image based on the second image feature comprises:
obtaining a target score of each of the plurality of second horizontal cropped images based on a second image feature of each second horizontal cropped image; and
obtaining a target score of each of the plurality of second vertical cropped images based on a second image feature of each second vertical cropped image.

8. The method according to claim 7, wherein obtaining the target score of each of the plurality of second horizontal cropped images based on the second image feature of each second horizontal cropped image comprises:
constructing a second graph with N second nodes based on a number N of the second horizontal cropped images, where N is a positive integer;
establishing a correspondence between an i^{th} second horizontal cropped image and an i^{th} second node, where i is a positive integer less than or equal to N;
determining an initial value of a feature of the i^{th} second node based on a second image feature of the i^{th} second horizontal cropped image;
inputting the second graph into a second graph neural network, and updating the feature of the i^{th} second node via the second graph neural network; and
obtaining a target score of the i^{th} second horizontal cropped image based on a last updated feature of the i^{th} second node.

9. The method according to claim 7, wherein obtaining the target score of each of the plurality of second vertical cropped images based on the second image feature of each second vertical cropped image comprises:
constructing a third graph with M third nodes based on a number M of the second vertical cropped images, where M is a positive integer;
establishing a correspondence between an s^{th} second vertical cropped image and an s^{th} third node, where s is a positive integer less than or equal to M;
determining an initial value of a feature of the s^{th} third node based on a second image feature of the s^{th} second vertical cropped image;
inputting the third graph into a third graph neural network, and updating the feature of the s^{th} third node via the third graph neural network; and
obtaining a target score of the s^{th} second vertical cropped image based on a last updated feature of the s^{th} third node.

10. The method according to claim 1, wherein determining the target cover image of the candidate resource from the plurality of first cropped images based on the aesthetic score of each first cropped image comprises:
determining a plurality of candidate cover images of the candidate resource from the plurality of first cropped images based on the aesthetic score of each first cropped image; and
determining the target cover image from the plurality of candidate cover images based on feedback data provided by a user group on the plurality of candidate cover images.

11. The method according to claim 10, wherein determining the target cover image from the plurality of candidate cover images based on the feedback data provided by the user group on the plurality of candidate cover images comprises:
obtaining an average reward of each of the plurality of candidate cover images based on feedback data corresponding to each candidate cover image;
obtaining an upper confidence bound score of the candidate cover image based on an exploration parameter, the average reward and a selection times of the candidate cover image; and
taking a candidate cover image corresponding to a maximum upper confidence bound score as the target cover image.

12. The method according to claim 11, further comprising:
updating the exploration parameter based on a sum value of selection times of the plurality of candidate cover images.

13. The method according to claim 1, further comprising:
identifying a first probability that the target cover image falls into a preference style of a user group; and
determining a recommended resource corresponding to the user group from a plurality of candidate resources based on the first probability.

14. The method according to claim 13, wherein identifying the first probability that the target cover image falls into the preference style of the user group comprises:
inputting the target cover image into a style recognition model, wherein the style recognition model comprises a second large model and a classification model;
obtaining a second probability of the target cover image under each of a plurality of style dimensions via the second large model; and
obtaining the first probability based on the second probability of the target cover image under each of the plurality of style dimensions via the classification model.

15. The method according to claim 14, wherein the second large model comprises a text encoder and an image encoder;
wherein obtaining the second probability of the target cover image under each of the plurality of style dimensions via the second large model comprises:
obtaining positive and negative prompt word pairs of H style dimensions, and inputting a positive and negative prompt word pair of a t^{th} style dimension into the text encoder, wherein each of the positive and negative prompt word pairs comprises a positive prompt word and a negative prompt word, H is a positive integer, and t is a positive integer less than or equal to H;
obtaining a first text feature by extracting a feature of a positive prompt word of the t^{th} style dimension via the text encoder, and obtaining a second text feature by extracting a feature of a negative prompt word of the t^{th} style dimension;
obtaining a third image feature by extracting a feature of the target cover image via the image encoder;
obtaining a positive probability of the target cover image under the t^{th} style dimension based on the first text feature and the third image feature;
obtaining a negative probability of the target cover image under the t^{th} style dimension based on the second text feature and the third image feature; and
taking the positive probability of the target cover image under the t^{th} style dimension and the negative probability of the target cover image under the t^{th} style dimension as a second probability of the target cover image under the t^{th} style dimension.

16. A method for training an image scoring model, comprising:
obtaining a reference cropped image and a sample cropped image of a sample image;
obtaining a coincidence parameter between each of the plurality of sample cropped images and the reference cropped image;
obtaining a slicing detection result of the sample cropped image by performing object slicing detection on the sample cropped image;
obtaining a sample aesthetic score of the sample cropped image;
obtaining a sample target score of the sample cropped image based on at least one of the coincidence parameter, the slicing detection result, or the sample aesthetic score; and
training an image scoring model based on the sample cropped image and the sample target score.

17. The method according to claim 16, wherein obtaining the coincidence parameter between each of the plurality of sample cropped images and the reference cropped image comprises:
obtaining an intersection over union (IoU) between a crop box of the sample cropped image and a crop box of the reference cropped image, and taking the IoU as the coincidence parameter.

18. The method according to claim 16, wherein a plurality of sample cropped images comprise a plurality of sample horizontal cropped images and a plurality of sample vertical cropped images, and the reference cropped image comprises a reference horizontal cropped image and a reference vertical cropped image,
wherein obtaining the coincidence parameter between each of the plurality of sample cropped images and the reference cropped image comprises:
obtaining a coincidence parameter between each of the plurality of sample horizontal cropped images and the reference horizontal cropped image, and taking the coincidence parameter as a coincidence parameter corresponding to each sample horizontal cropped image; and
obtaining a coincidence parameter between each of the plurality of sample vertical cropped images and the reference vertical cropped image, and taking the coincidence parameter as a coincidence parameter corresponding to each sample vertical cropped image.

19. An apparatus for obtaining a cover image, comprising:
at least one processor; and
a memory communicatively coupled to the at least one processor,
wherein the memory stores instructions executable by the at least one processor, the instructions causes the at least one processor to:
obtain a plurality of first cropped images of an original image corresponding to a candidate resource;
obtain an aesthetic score of each of the plurality of first cropped images; and
determine a target cover image of the candidate resource from the plurality of first cropped images based on the aesthetic score of each first cropped image.

20. An apparatus for training an image scoring model, comprising:
at least one processor; and
a memory communicatively coupled to the at least one processor,
wherein the memory stores instructions executable by the at least one processor, the instructions causes the at least one processor to implement the method of claim 16.
